(19) United States
(12) Patent Application Publication
(10) Pub. No.: US 2014/0141846 A1
(43) Pub. Date: May 22, 2014

(54) COVER OR DEVICE WITH A SOUND CONCENTRATOR

(71) Applicant: Robert B. Weaver, III, Caledonia, MI (US)

(72) Inventor: Robert B. Weaver, III, Caledonia, MI (US)

(21) Appl. No.: 13/987,307

(22) Filed: Apr. 9, 2012

(51) Int. Cl. H04M 1/03

(52) U.S. Cl. CPC H04M 1/035
USPC 455/575.1

(57) ABSTRACT

A cover for a handheld device having a device body and a speaker. The cover includes a cover body which is configured for covering at a portion of the device body and for covering the speaker. The cover body forms an outlet opening. The cover further includes a channel for communication with the speaker and for harnessing and concentrating sound waves from the speaker to the outlet opening, with the channel having a length and a cross section increasing in magnitude along the length of the channel.

### TECHNICAL FIELD AND BACKGROUND OF THE INVENTION

The expanding use of cellular smart phones and tablet PC devices to listen to music, watching videos or movies, and playing games has given rise to a demand for better sound quality.

However, due to the extremely tight size and spatial constraints, and vital importance of the front screen face geometry, most devices have internal speaker systems that provide minimal sound quality and typically from one monophonic speaker sound source. This sound source is typically located at the back face of the device, or near the outer edge of the device. In each case, the majority of sound energy is directed away from the primary user of the device. The remaining sound energy that is directed towards the primary device user typically arrives to the user's ear as a weak monotone and asymmetrical sound source that is easily overpowered by moderate ambient perimeter noise. With the ever-expanding use of these devices to play games, listen to music, and, in some cases, to watch movies, a better sound quality would, therefore, be highly desirable.

### SUMMARY OF THE INVENTION

Accordingly, the present invention provides a sound concentrator that can be incorporated into a cover or into a device itself to improve the quality of the sound emitted from the speakers or sound emitting devices of the device.

In one form of the invention, a cover for a handheld device (with a device body and a speaker) includes a cover body, which is configured for covering at a portion of the device body and for covering the speaker or stereo speaker pair. The cover also includes a channel for communication with the speaker and for directing sound waves from the speaker to an outlet opening formed by the cover body, with the channel having a length a cross section increasing in magnitude along the length of the channel for harnessing and concentrating the sound emitted from the speaker and directing the sound waves to the outlet opening.

In one aspect, the cover body forms a plenum space, with the channel in communication with the plenum space for directing the sound waves to the plenum space, which is in communication with the outlet opening.

In another aspect, the cover body includes a base wall and a perimeter wall. The perimeter wall extends around and from the base wall and forms the opening and also an outlet chamber about the opening for positioning adjacent a portion of the device body.

In a further aspect, the side wall of the cover body forms the outlet chamber at a corner of the cover for positioning adjacent a corner of the device.

According to another aspect, the side wall of the cover body forms at least three outlet chambers located around the perimeter of the device body.

In yet another aspect, the cover body includes a base wall and a perimeter wall, with the base wall having the opening.

According to yet another aspect, the channel is formed by a pair of side walls, which diverge in the direction of the plenum space.

Optionally, the cover further includes a second channel, the second channel in communication with the plenum space and the opening for directing the sound waves from the plenum space to the opening. Similarly, the second channel may be formed by a pair of side walls, which diverge in the direction of the opening.

In yet another form of the invention, an electronic hand-held device includes a device body and a speaker. The device body has a channel which has a closed cross section for harnessing and concentrating sound waves emitted by the speaker and for directing sound waves from the speaker to an outlet chamber spaced from the speaker.

According to another form of the invention, a cover for a handheld device with a device body and a speaker includes a cover body, which is configured for covering at a portion of the device body and for covering the speaker and which forms an outlet opening. A plenum space is formed by the cover body or by an insert in the cover body, which is in communication with the speaker for directing sound waves from the speaker to the outlet opening.

In one aspect, the cover body or insert is adapted to absorb and thereby filter a selected range of frequencies of the sound wave. For example, the cover body or insert may include a material or structure that absorbs and thereby filters the selected range of frequencies of the sound wave. The cover body or insert may include a coating applied thereto that absorbs and thereby filters the selected range of frequencies of the sound wave.

In another aspect, the cover also includes a channel, which is in communication with the plenum space and the speaker for harnessing and concentrating sound waves emitted by the speaker. The plenum space is in direct communication with the outlet opening or indirect communication with the outlet opening by way of another channel.

In yet another form of the invention, an electronic hand-held device includes a housing with an outlet opening, a speaker spaced from the outlet opening, and a plenum space in communication with the speaker and the outlet opening for directing sound waves emitted from the speaker to the outlet opening.

In one aspect, the device further includes a channel that is in communication with the speaker and the plenum space for harnessing and concentrating the sound waves emitted from the speaker. For example, the channel may have a closed cross-section that increases in magnitude in the direction from the speaker to the plenum space.

In yet another form, a method of directing sound from a speaker in a hand-held device includes harnessing the sound waves emitted from the speaker, adjusting the sound waves, and outputting the adjusted sound waves at a location spaced from the speaker.

For example, the adjusting may include concentrating the sound waves at the location or concentrating the sound waves at two or more locations spaced from the speaker. In another or additional aspect, the adjusting includes absorbing a selected frequency of the sound waves to thereby filter the selected frequency.

Accordingly, when mounted to or in a handheld device with one or more speakers, the plenum space or channels of the present invention provide improved sound volume and/or quality.

### DESCRIPTION OF THE FIGURES

FIG. 1 is a perspective view of a cover of the present invention shown mounted to a handheld device in the form of a cell phone;

FIG. 2 is a top plan view of the cover with the device removed to show the internal structures of the cover;

FIG. 3 is a bottom plan view of the cover of FIG. 2;

FIG. 4 is a side view of the cover of FIG. 2;

FIG. 5 is an end view of the cover of FIG. 2;

FIG. 6 is another end view of the cover of FIG. 2;

FIG. 7 is another side view of the cover of FIG. 2;

FIG. 8 is a plan view of another embodiment of the cover shown mounted to a handheld device (shown in phantom);

FIG. 9 is a plan view of the cover with the device removed to show the internal structures of the cover;

FIG. 10 is a perspective view of the cover of FIG. 8;

FIG. 11 is a bottom plan view of the cover of FIG. 8;

FIG. 12 is a side elevation view of the cover of FIG. 8;

FIG. 13 is a cross section view taken along line XIII-XIII of FIG. 8;

FIG. 14 is a fragmentary view of the cover of FIG. 8;

FIG. 15 is a cross section view taken along line XV-XV of FIG. 8;

FIG. 16 is a cross section view taken along line FIG. XVI-XVI of FIG. 8;

FIG. 17 is a side view of the cover of FIG. 8;

FIG. 17A is an exploded perspective view of a modified version of the cover of FIG. 18;

FIG. 17B is a perspective view of the cover of FIG. 117A;

FIG. 17C is a cross-section through the cover of FIG. 17A;

FIG. 17D is an enlarged fragmentary view of the cover of FIG. 17A;

FIG. 18 is a plan view of another embodiment of the cover of the present invention shown mounted to a handheld device in the form of a cell phone;

FIG. 19 is a perspective view of the cover of FIG. 18 removed from the handheld device illustrating the internal structure of the cover;

FIG. 20 is a top plan view of the cover of FIG. 19;

FIG. 21 is a bottom plan view of the cover of FIG. 19;

FIG. 22 is a side view of the cover of FIG. 19;

FIG. 23 is another side view of the cover of FIG. 19;

FIG. 24 is an end view of the cover of FIG. 19;

FIG. 25 is a perspective view of another embodiment of a cover the present invention mounted to a handheld device in the form of a cell phone;

FIG. 26 is a perspective view of the cover removed from the handheld device illustrating the internal structures of the cover;

FIG. 27 is an exploded perspective view of the cover of FIG. 26;

FIG. 28 is an enlarge perspective view of the bottom half of the cover of FIG. 26;

FIG. 29 is a perspective view of another embodiment of a cover the present invention mounted to a handheld device in the form of a cell phone;

FIG. 30 is a perspective view of the cover removed from the handheld device illustrating the internal structures of the cover;

FIG. 31 is a perspective view of the back of the cover of FIG. 30;

FIG. 32 is another perspective view of the back of the cover of FIG. 30;

FIG. 33 is a perspective view of a device incorporating the sound wave harness and concentrating technology of the present invention; and

FIG. 34 is an exploded perspective view of the removal of a standard back panel and front panel of a device and replacement with a back panel and front panel of the present invention incorporating the sound wave harness and concentrating technology of the present invention.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### DETAILED DESCRIPTION OF THE PREFERRED EMBODIMENTS

Referring to FIG. 1, the number 610 generally designates a cover for handheld electronic device, which is configured to harness the sound emitted from one or more the speakers of the device and, further, to direct the sound to one or more locations remote from the speaker. While hereinafter reference will be made to a “speaker,” it should be understood that the term “speaker” is used broadly and is intended to cover any component that emits audible sound waves from a handheld device to convey, for example, music sounds, sound effects, voice sounds or the like. Further, in the illustrated embodiment, the handheld electronic device D comprises a cell phone, which is illustrated with a touch screen display identified by the letter T. However, it should be understood that other types of cell phones may be used, and that the cover may be used on other types of handheld devices, such as a pad or a tablet or other handheld electronic devices that emit sound. Additionally, as will be more fully described below, cover 610 may also be adapted to absorb some of the sound frequencies, for example some of the high frequency sounds, to reduce the tinny sound and provide a more pleasing sound for the user of the device.

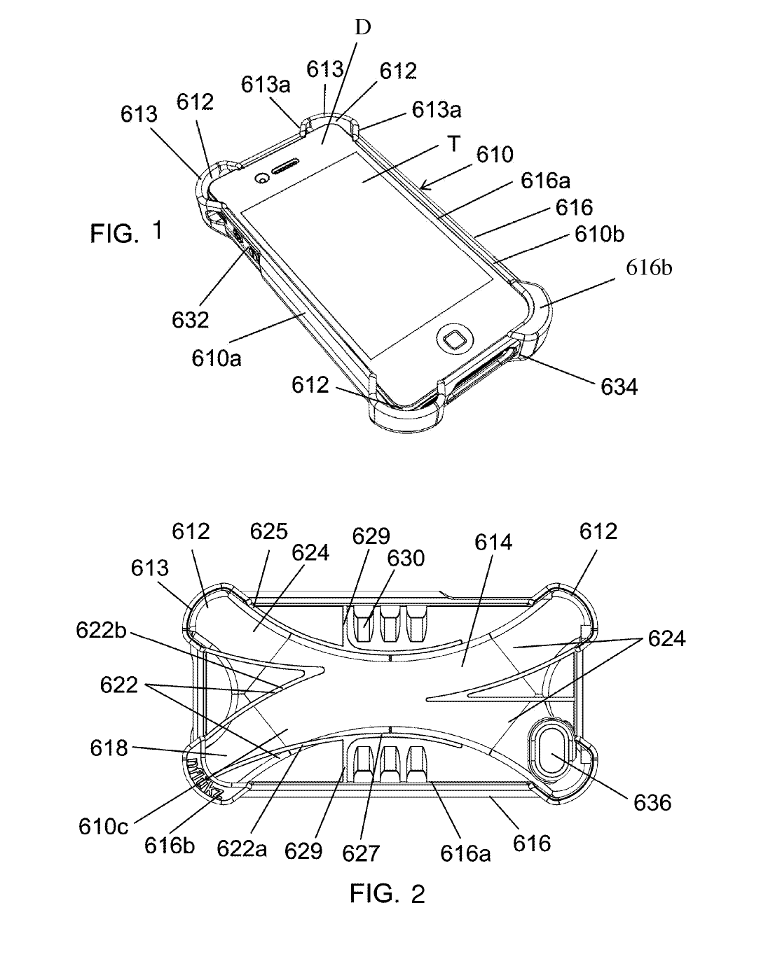

As best understood from the FIGS. 1 and 2, cover 610 is configured to cover at least a portion of the device and further form outlet openings at two or more selected, discrete locations around the device through which the sound from the speaker is directed. For example, in the illustrated embodiment, a first group of outlet openings 612 is located at the corners of the device D facing the user. However, it should be understood that the outlet openings may be formed at different locations around the device, depending on the device configuration and/or the preference of sound direction. With the outlet openings oriented at the front face of the device, cover 610 directs the sound waves from the speaker in the direction of the user and, further, as will more fully described below, in a manner that gives the perception of increased volume.

In the illustrated embodiment, cover 610 includes a cover body with a base wall 614, which when mounted to the device is spaced from the device body, and an upwardly extending perimeter side wall 616 which together form a plenum space between the device body and the cover. Further, the cover may be configured and arranged to seal against the device body around the speaker (or speakers) so that essentially all of the potential audible sound energy developed by the speaker (or speakers) of the device can be harnessed and concentrated by the cover so that essentially all of the sounds wave can be directed to the listener's ear.

Referring again to FIG. 1, side wall 616 includes a downwardly extending lip 616a that optionally seals against the device body along the front facing sides and ends of the device but which then diverges away from the device body over several discrete regions to form the outlet openings or spaces between the cover and the device body and further to form the outlet chambers 613 around openings 612, which direct the sound harnessed in the plenum space out from cover 610. As noted, in the illustrated embodiment, these outlet chambers are formed at the three corners of the device and face the user so that sounds harnessed in the plenum space can travel from the chambers in the direction of the user.

In the illustrated embodiment, side wall 616 includes flared regions that form chambers 613 at three corners of the device, which configuration creates gripping surfaces 613a around the cover, which may be especially desirable when using the device as a gaming device. The side wall 616 also includes an extended flange 616b over the fourth corner to cover and optionally seal around the speaker and direct essentially all the sound from the speaker into to the plenum space formed between the base wall of the cover and the device body.

Referring to FIG. 2, to redirect the sound from the speaker to the plenum space and then to the corners of the device, cover 610 incorporates at least one channel 618 which is in communication with the speaker on one end and in communication with a chamber 620, which forms part of the plenum space, at its distal end. The chamber 620 may be directly in communication with each of the outlet chambers 613 or may be in communication with one or more outlet chambers 613 by way of additional channels described below. Channel 618 is formed by upwardly standing side walls 622, which are optionally integrally formed with base wall 614 of cover 610, such as by molding or by being post applied using an adhesive. Further, upwardly standing side walls 622 are sized such that the upper distal edge of the respective side wall 622 extends to and optionally seals against the back of the device body (when the cover is mounted to the device) so that all of the sound waves emitted from the speaker are directed along the channel. Thus essentially all of the sounds waves emitted from the speaker will travel up channel 618 from its proximal end (adjacent to the speaker) to its distal end adjacent central chamber 620 and thereafter travel to outlet chambers 613.

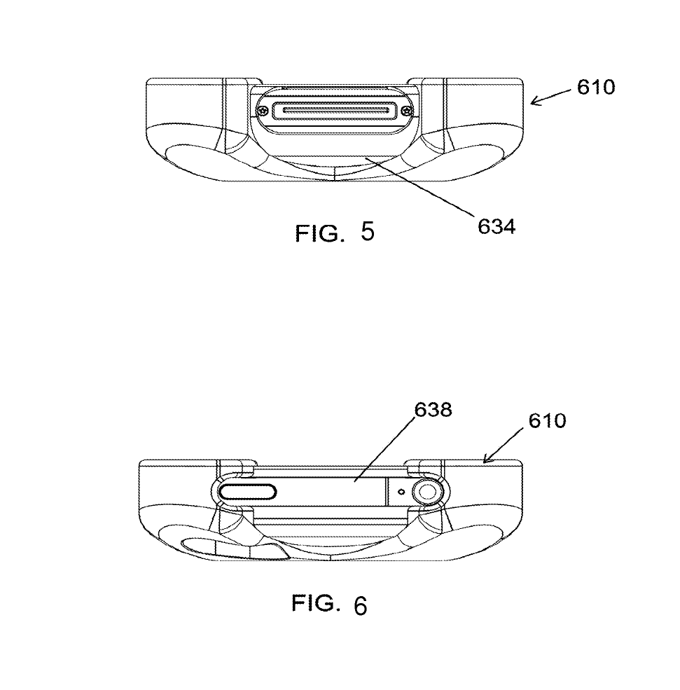

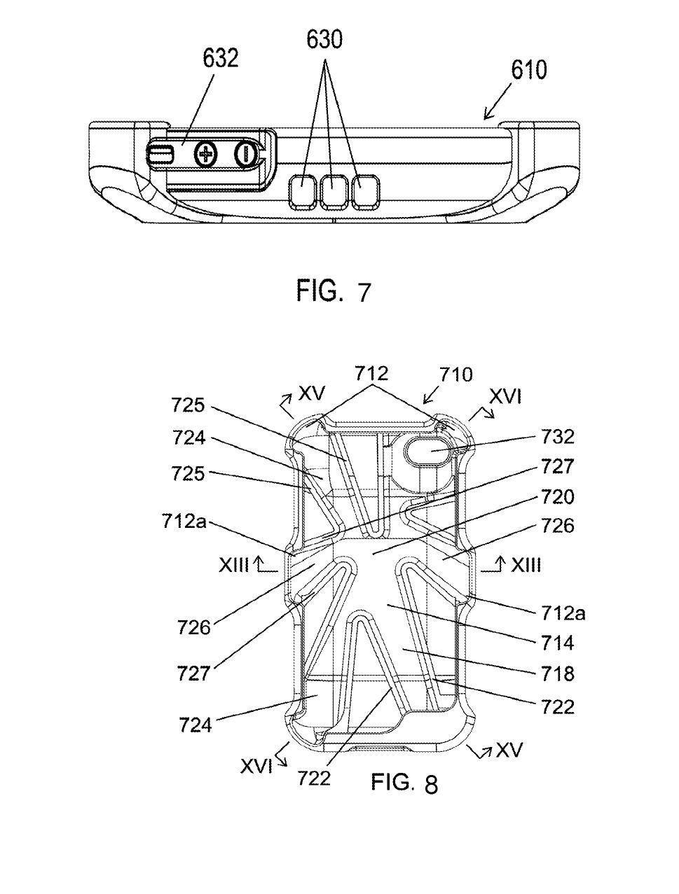

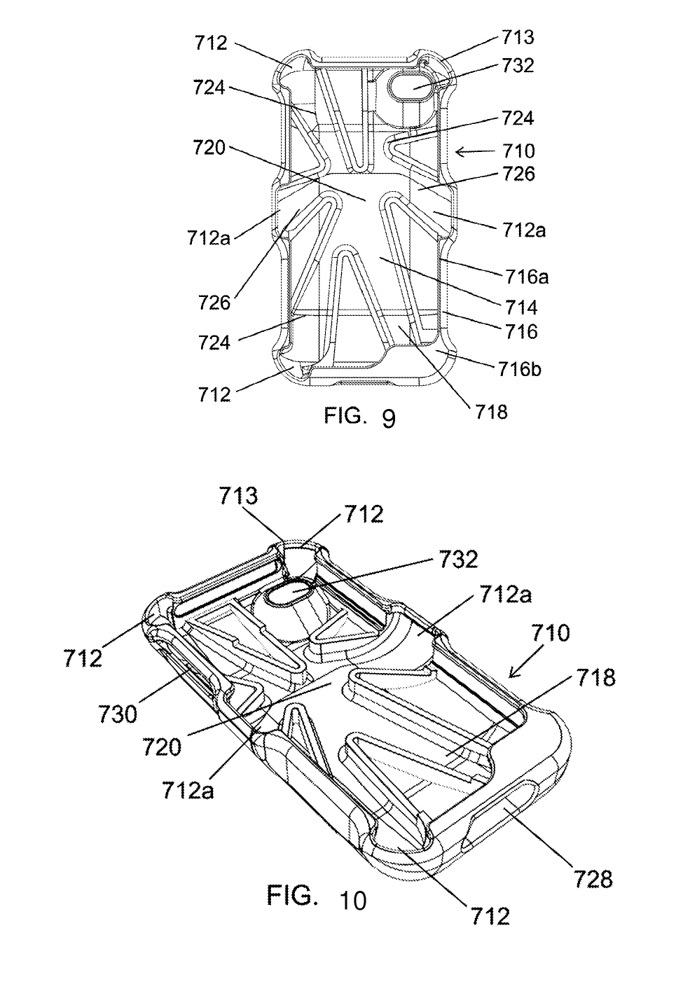

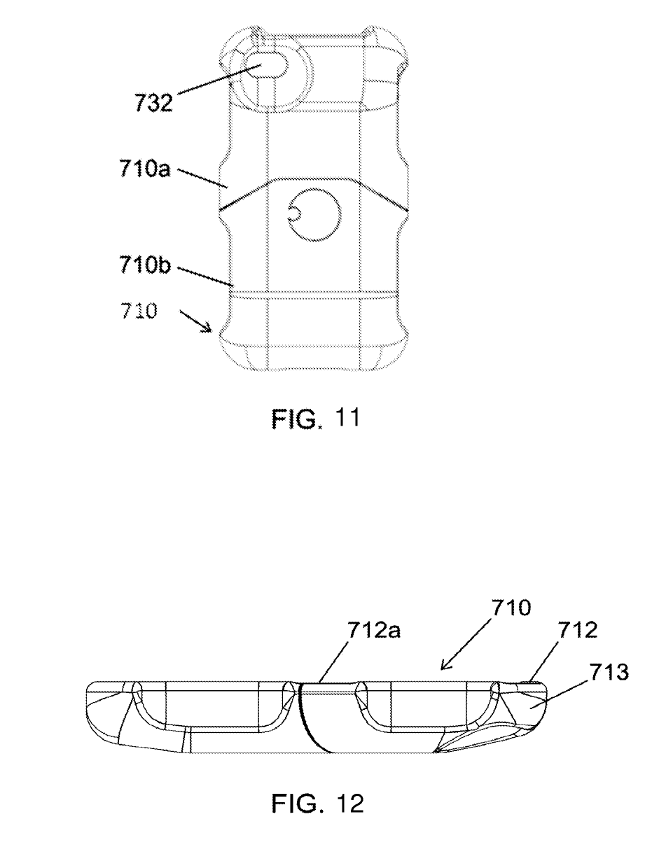

Optionally, channel 618 may be configured to operate like an internalized megaphone within the handheld device case or within the handheld device itself (as described more fully below). For example, walls 622 may be a tapered so that channel 618 concentrates the sounds waves and thus prevents them from scattering. Optionally base wall 614 of cover may be flat or may have a slope, such as shown in FIG. 4, to thereby form a generally cone or horn shaped channel. In addition, walls 622 may be curved to reduce interference with the sound waves.

Referring to FIG. 2, cover 610 optionally includes additional secondary channels 624 which provide communication between central chamber 620 and outlet chambers 613 to further enhance the transmission of the sound waves from the central chamber 620 to the outlet chambers 613. Cover 610 may also incorporate openings 630 in base wall 614 to allow the sound waves to emanate from the back of the cover 610, which may also help with reducing echoes, which will be more fully described below. To direct the sound waves to openings 630, cover 610 may incorporate another set of secondary channels or may locate them at the end of channels 624, such as shown in FIG. 2, which can create a coffered space. Additionally channels 624 may also be tapered such their respective side walls 625 diverge and concentrate the sound waves as they travel from the central chamber 620 to chambers 613 and optional openings 630. Similarly, back wall 614 may taper from the proximal end of the respective channels 624 to the distal end of the respective channels to thereby form generally cone or horn shaped channels to further enhance the concentration of the sound waves.

In the illustrated embodiment, channels 624 are formed upwardly standing walls 625, 627, which are also optionally integrally formed with base wall 614 of cover 610 (such as by molding, stamping etc (see below for various methods for forming the cover) or by being post applied using an adhesive or mechanical attachment) and further are sized such that the upper distal edge of the respective side walls 625 extends to and optionally seals against the back of the device body (when the cover is mounted to the device). To direct the some of the sound waves to openings 630, walls 627 terminate before reaching outlet openings 612, which forms a coffered space and directs some of the sound waves to openings 630 and reduces, if not eliminates, reflections or echoes that may occur. The terminal end of that channel is then optionally closed by another upstanding wall 629, which is also size to extend to and optionally seal against the back of the device.

In addition, similar to walls 622, walls 625 and 627 are curved to create a smooth pathway for the sound waves. Further, wall 622a transitions into wall 627 forming a continuous smooth curve. Similarly, the curve of the opposed wall 622b projects onto and aligns with the curve of wall 625, which again creates a smooth pathway for the sound waves. With this configuration, it has been found that echoes are significantly reduced if not eliminated and further the sound transmission is more efficient so the perceived volume of the sound waves as they exit the cover is noticeably increased in volume.

As would be understood, therefore, all the walls forming the respective channels extend up to and optionally contact the rearward facing surface of the device and, further, optionally thereby seal the respective channels to the back side of the device so that essentially all the sound waves which are emitted from the speaker are directed through the respective channels to the outlet openings. For example, the height of the respective wall 622, 625, 627, and 629 may range from about 2 mm to 15 mm within a smartphone assembly, optionally from 2 mm to 50 mm within a tablet assembly. Furthermore, the thickness of the respective walls may vary in a range from about 0.5 mm to 3 mm. The length of the channels also may vary. For example, the length of the respective channels 618 and 624 may range from about 10 mm to 175 mm within a smartphone assembly, optionally from about 10 mm to 400 mm within a tablet assembly. Additionally, when base wall 614 is sloped, the height of the respective walls may vary to follow the taper of the back wall and therefore may range about 2 mm to 15 mm at their shortest height to about 5 mm to 30 mm at their tallest height within a smartphone assembly, which typically corresponds to their locations adjacent base central chamber 620. Further, the angle of taper on the channels may vary. For example, the angle of taper may vary from about 0.5 to 45 degrees.

Referring again to FIG. 2, each side of the walls forming the channels has a smooth transition with the base wall to avoid any sharp angles, which could distort the sound waves. Similarly, the walls of adjacent channels may be joined with smooth transitions, again to avoid any sharp angles and minimize sound distortion.

Depending on the particular device, cover 610 may also include various access openings 632, 634, 636, and 638 to provide access to the controls of the phone, ports and further not to interfere with a camera of the device. In each case, the cover extends to and optionally seals against the device body around each access opening to minimize or prevent sound leakage.

Depending on the material forming cover 610 (see below), cover 610 may have a split construction with an upper half 610a and a lower half 610b which couple together by way of a friction fit or snap fit connection. For example, lower half 610b may include a flange that extends into upper half 610a and then frictionally engages the inwardly facing surface of the lower end of upper cover half 610a. While the term “half” is used, it is used loosely to mean that the cover has two parts. It should be understood that the location of the split 610c is not necessarily in the middle and. therefore, each half of the housing is necessarily not of equal size.

Similarly, the cover may be formed out of a semi-flexible or flexible material that will allow the smartphone or tablet to be placed inside of the case by way of stretching and flexing the perimeter of the case around the perimeter of the smartphone/tablet, and creating a secure post-stressed tensioned fit between the case and smartphone/tablet.

Referring to FIG. 8, the numeral 710 generally designates another embodiment of a cover of the present invention. Cover 10 is similar to cover 610 and includes a plurality of outlet openings 712 and outlet chambers 713 formed at three of the corners of the device for directing sound outwardly from the face of the device. Cover 712 further includes two side chambers 713a located at the front face of the device along the sides of the device, which are generally located midway along the length of the sides of the device and which similarly direct sound outwardly from the face of the device.

In a similar manner to the first embodiment, cover 710 includes a back wall 714 with one or more channels 718 that capture and direct the sound waves from the speaker (which is also located in the lower right hand corner of the device) to a central chamber 720, which in turn is in communication with a plurality of channel 724 and 726 for directing the sound waves to the respective forwardly facing chambers 713 and 712a. The shape of chambers 713 and 712a also provide pronounced griping surfaces, which are formed by the transition regions of the cover's side wall adjacent chambers 713 and 712a.

Channel 718, 724 and 726 are also similarly formed by upstanding walls 722, 725, 727, which extend to and optionally seal against the device body. In a similar manner the respective walls of the channels diverge and are tapered to concentrate the sound waves emitted from the speaker(s) so the volume of sound emitted from the outlet chambers of the cover appears to be greater than the sound from the device without the cover. Again, cover 710 incorporate several openings 728, 730, and 732 to provide access to the ports and controls of the phone, as well as the camera, which are optionally sealed to the device body around the respective accessory. Further, cover 710 may also incorporate a split construction.

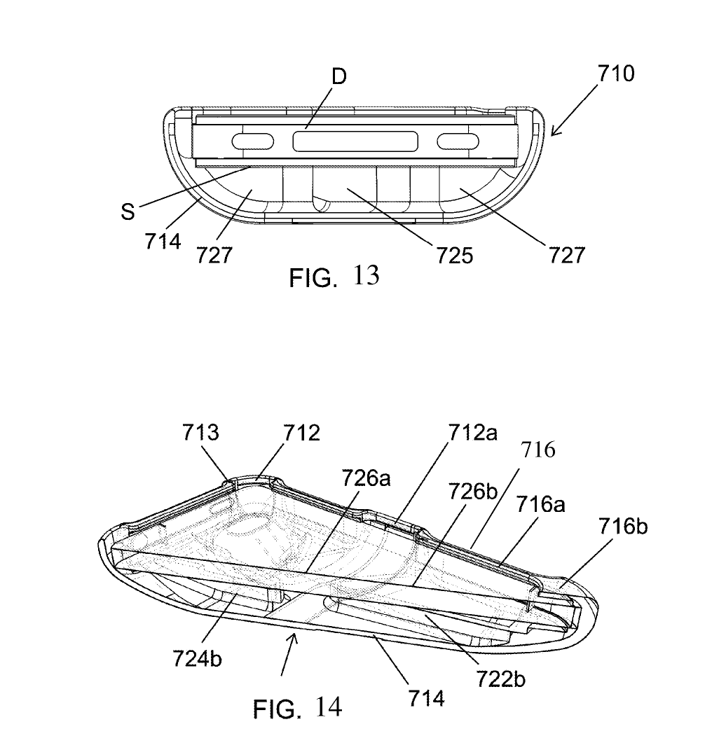

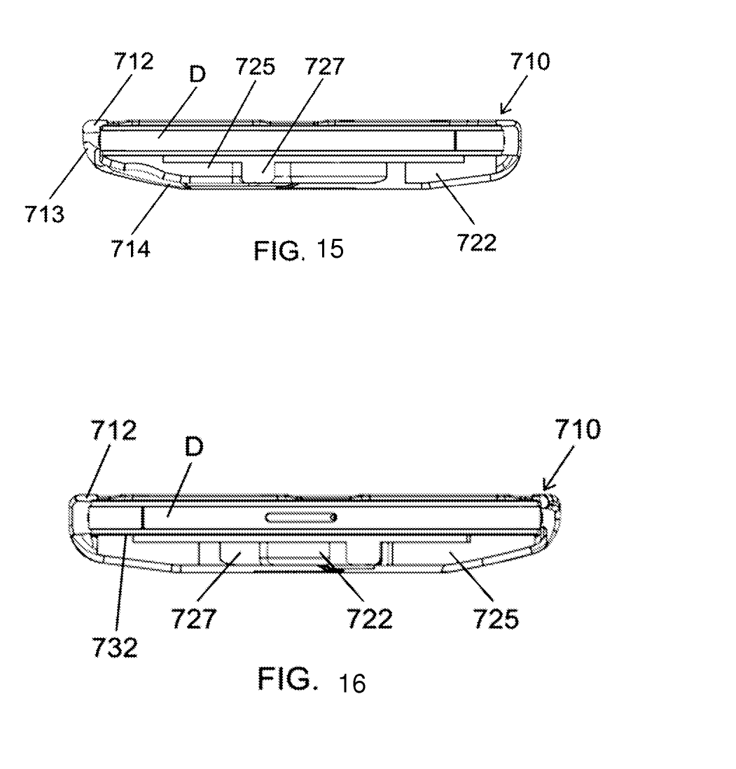

Referring to FIGS. 13-16, and as noted in reference to cover 610, all the walls forming the respective channels extend up to and contact the rearward facing surface of the device to thereby seal the respective channels to the back side of the device so that essentially all the sound waves which are emitted from the speaker are directed through the respective channels to the outlet chambers adjacent to the corners on the sides of the device. For examples of suitable dimensions reference is made to cover 610.

Additionally, cover 710 may be adapted to hold articles, such as credit cards, business cards to name a few. For example, some of the walls forming the channels may be shortened and then joined by a web to close the channels and also to form a shelf on which a card may be supported. Alternately, the walls may be simply shorted, with the card(s) then closing the channel. In the case of a cover with a split construction, one half of the cover may be mounted to the device, and then the card inserted into the space between the web (or upper edges of the walls) and the device, and then the other half can be slipped over the card and then inserted into or onto the other half of the cover. Alternately, the cover may incorporate an external pocket for receiving articles, such as credit cards, personal driver's license, and/or key.

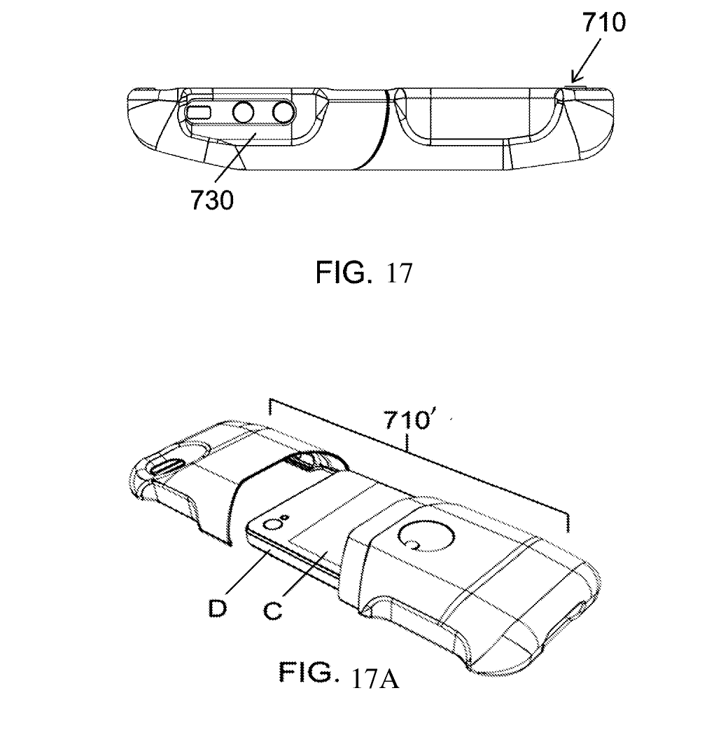

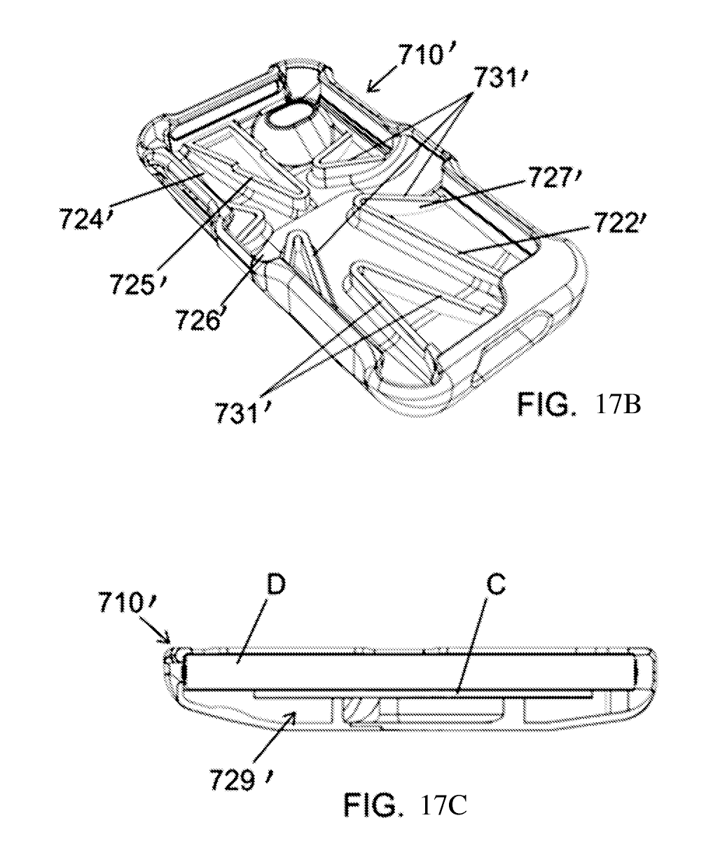

Referring to FIGS. 17A-17D, cover 710′, a slightly modified version of cover 710, includes a shelf 729′ formed by the upper edges 731′ of walls 725′ and 727′ of the respective channels 724′ and 726′, which are formed with regions of shorter height during the cover forming process or shorted after the cover forming process so as to create a recessed shelf for receiving a credit card C. In this manner, when cover 710′ is mounted to a device D. the credit card will be held between the cover and the device but in a manner not to interfere with the sound wave harnessing and concentration described in reference to cover 710.

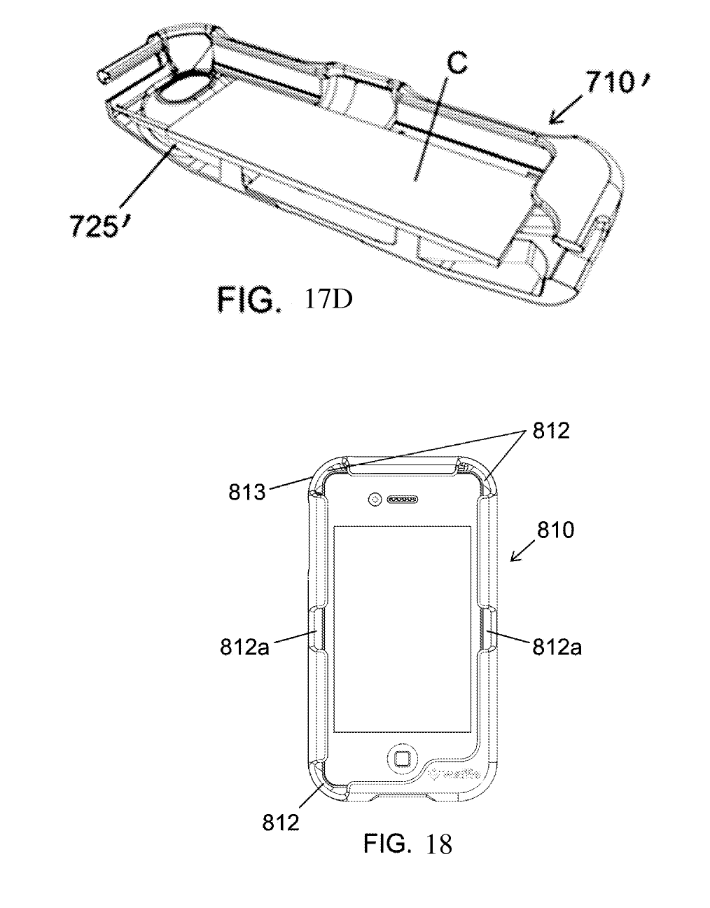

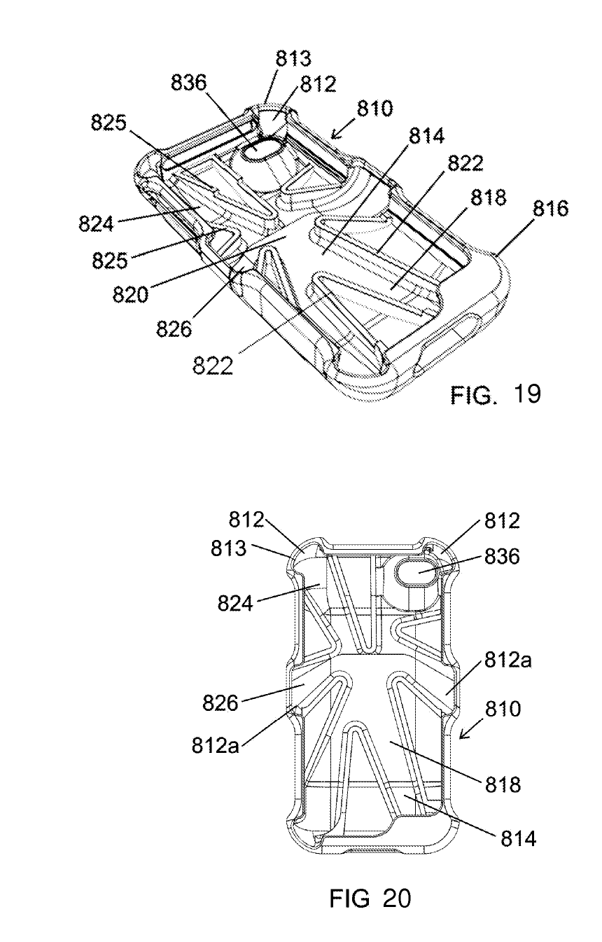

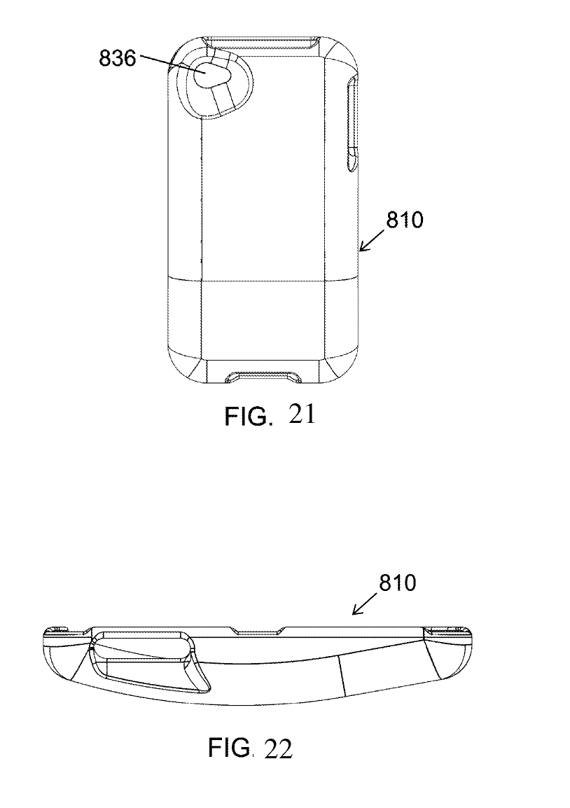

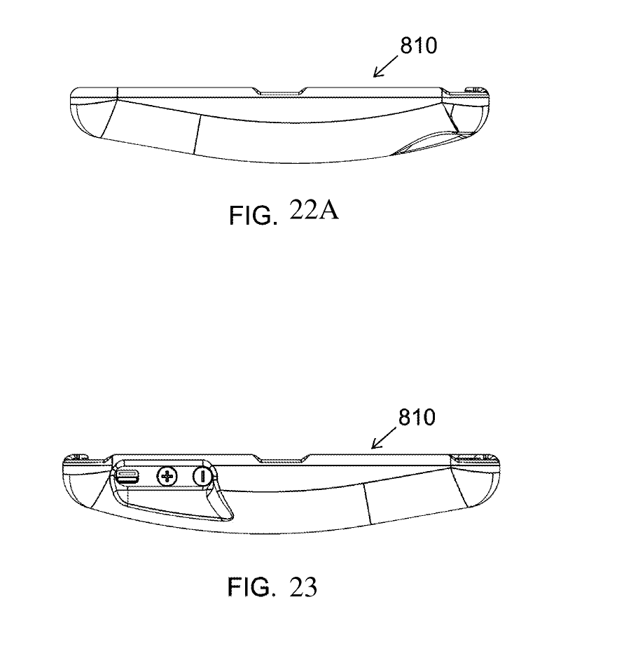

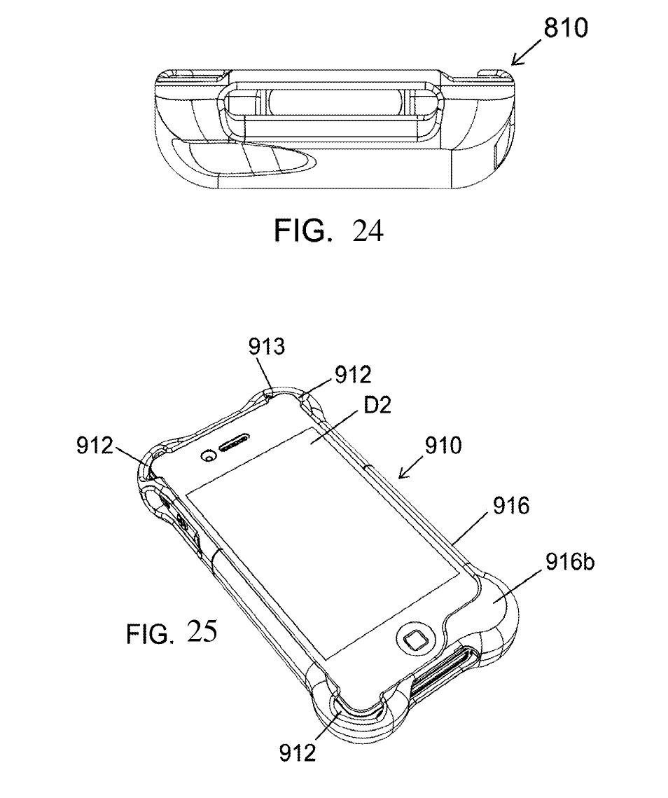

Referring to FIG. 18-24, 810 generally designates yet another embodiment of the cover of the present invention. Cover 810 is similar to cover 710 in that it includes outlet chambers 813 at three corners of the device and side outlet chambers 813a along the side of the device D, which may be generally located midway along the length of the sides of the device. Referring to FIG. 19, cover 810 similarly includes a base wall 814 with upwardly standing walls 822 which form channels 818, 824, and 826 for directing the sound from the speaker (which is also located at the right hand corner) to the various chambers around the perimeter of the device. In contrast to cover 710, each respective chamber 812 and 812a is generally smaller than the corresponding chambers for cover 710 to provide a more streamlined cover, but which also eliminates the pronounced griping surfaces provided by the transition region formed adjacent chamber 712 and 712a of cover 710. Cover 810 may also incorporate a split construction.

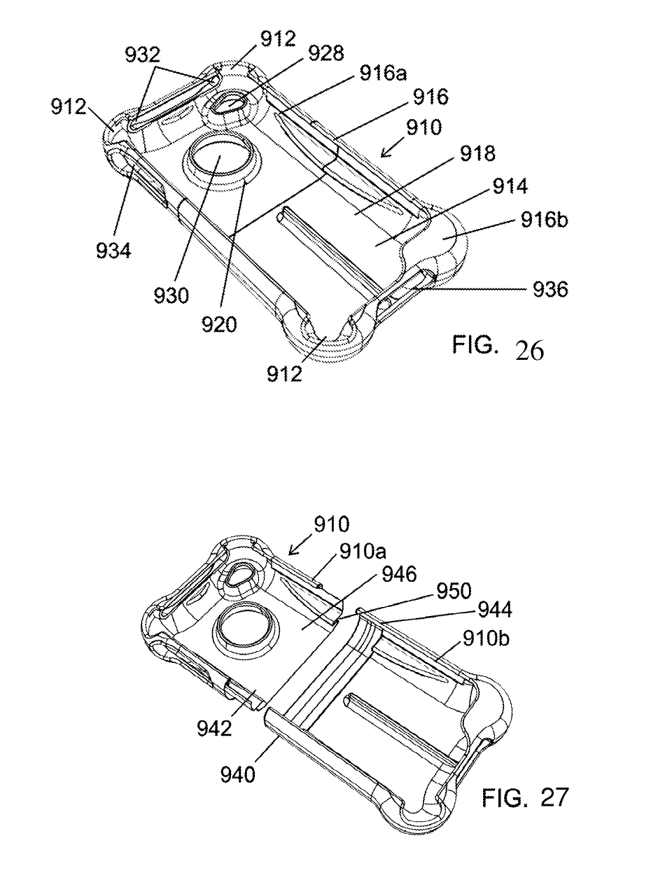

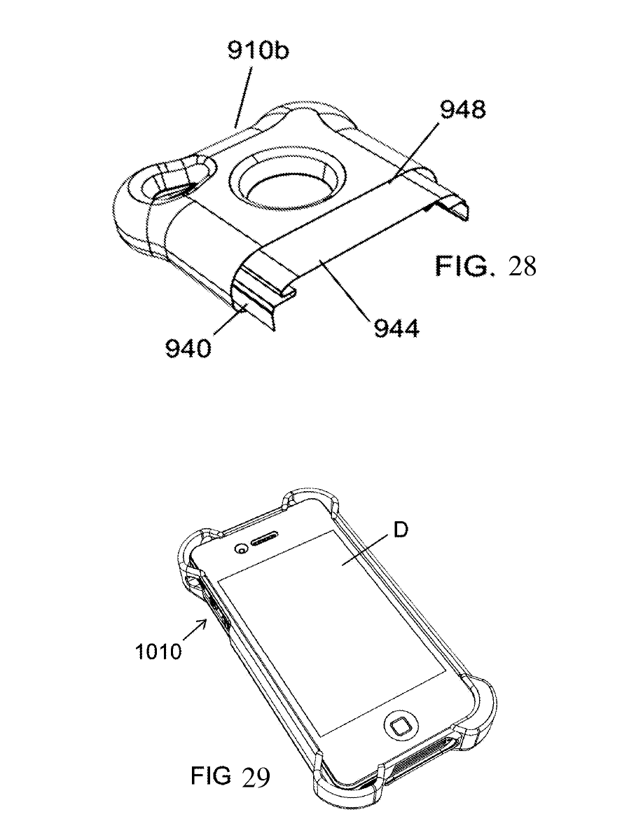

Referring to FIGS. 25-27, the numeral 910 generally designates yet another embodiment of a cover the present invention. Similar to cover 710, cover 910 includes enlarged chambers 913 of three of the respective corners of the device D, which tend to further increase the sound output from the cover and device. In the illustrated embodiment, cover 910 includes a single channel 918 that is in communication with a speaker (which is similarly located at the lower right hand side of the device as viewed from FIG. 25), which directs the sound from the speaker inwardly behind the device between the device body and the cover into the central enlarged chamber 920 which is in communication with the respective chambers located around the three corners of the device. In this manner, cover 910 adopts a simplified approach to harnessing and concentrating the sound waves and further distributing the sound waves to its respective outlet chambers located remotely from the speaker. Again, each of the covers may incorporate different access openings to accommodate the various devices. For example, cover 910 includes two rearwardly extending openings 928 and 930 which are configured to provide access to allow use of the camera and visibility of smartphone logo. Additional access openings 932, 934 and 936 may also be provided to allow access to the ports and controls of the specific device to which cover 910 is mounted. Again, to minimize sound leakage the cover may be sealed against the device body around each of the access openings.

Similar to the previous embodiments, cover 910 optionally incorporates a split construction with an upper half 910a and lower half 910b, which couple together by way of a friction fit or snap fit connection between a flange 940 formed on lower cover half 910b and the inwardly facing surface 942 of the lower end of upper cover half 910a. Optionally, flange 940 may incorporate a recess or other surface relief for cooperating with a corresponding relief 946, such as raised relief, on upper cover half 910a to provide a snap fit coupling between the two cover halves.

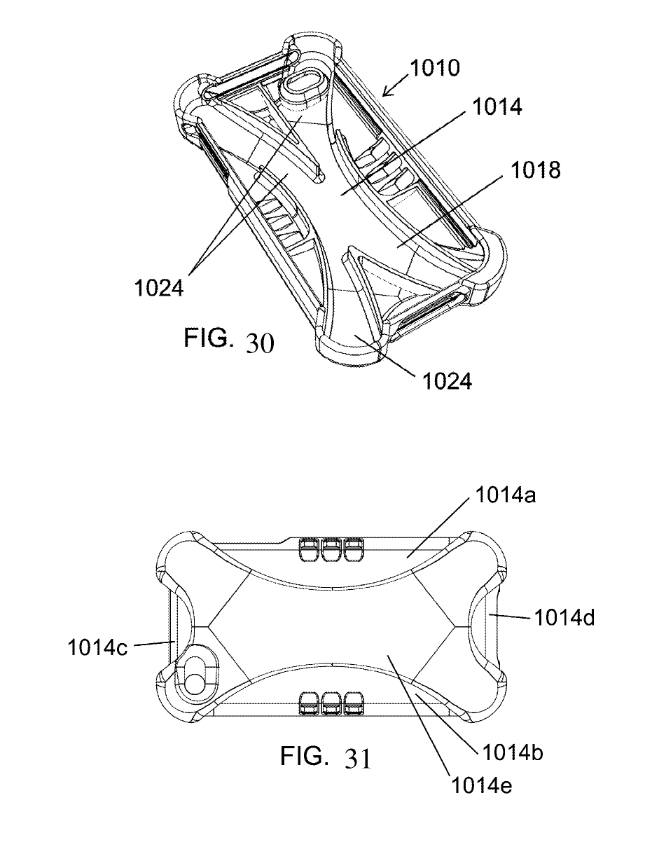

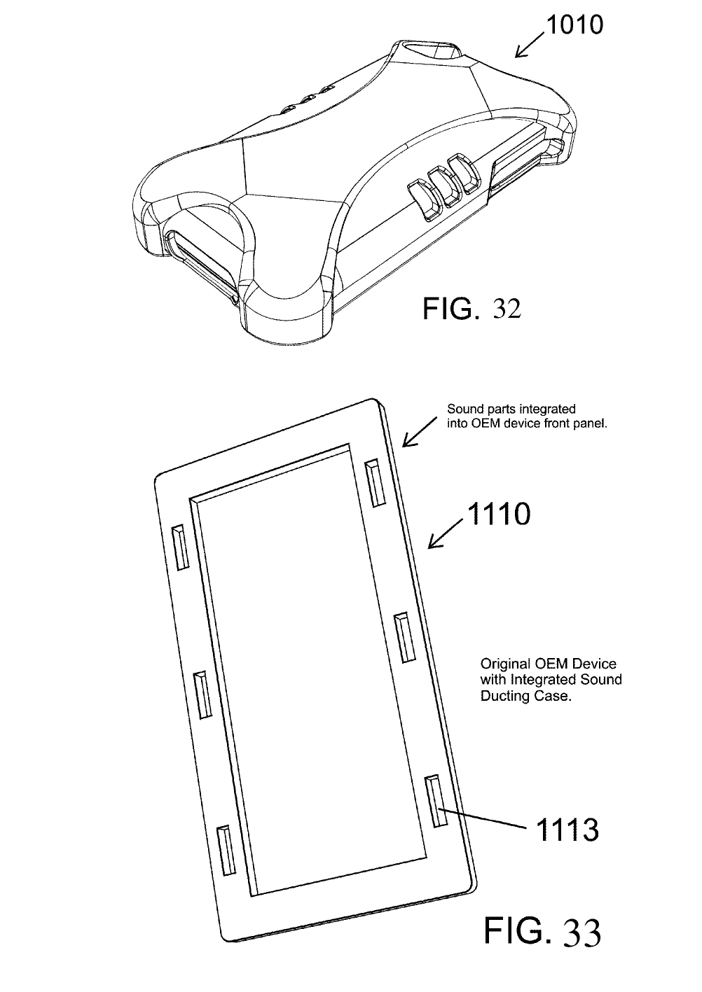

Referring to FIGS. 29-32, the numeral 1010 generally designates yet another embodiment of a cover the present invention. Cover 1010 is similar to cover 610 but is formed as a unitary cover. Thus, as noted, the base wall 1014 of cover 1010 may be formed from sections 1014a, 1014b, 1014c and 1014d, which are preformed as inserts from a relatively rigid polymeric material, such as a plastic, and which are placed into a mold and then molded with a second material over the inserts, which forms the back wall 1014e and balance of the base wall 1014. Back wall 1014e is formed from a more flexible and energy absorbing material, such as a structural gel, silicone, rubber or other elastomeric materials so that the cover can be stretched or bent to fit over the device. Alternately, cover 1010 may be formed from two shot molding with a first material for forming section 1014a, 1014b, 1014c and 1014d and the second material for forming the more flexible back wall. For further details of cover 1010 reference is made to cover 610.

Further, back wall 1014e is formed with a more defined offset from base wall 1014 so that the depth of the channels 1018 and 1024 may be increased and further more rounded to further increase the smoothness of the respective channels. In this configuration, it has been found that echoes are even more reduced if not eliminated and further the sound transmission is even more efficient so the perceive volume of the sound waves as they exit the cover is noticeably increased, even over the other illustrated embodiments.

In an alternate embodiment, the plenum space and/or channels for sound harnessing and concentrating the sound of the cover may be incorporated into a separate insert that is inserted between the cover and the device body or interiorly of the device itself. Further, as described below, the plenum space and/or channels may be incorporated into the device body itself. For example, the inside of the device body or the device body wall itself may incorporate a plenum and/or internal channels that are in communication with the speaker(s) and with one or more outlet chambers formed in the device body, for example, formed at the corners and/or sides of the device body and/or at the back side of the device body.

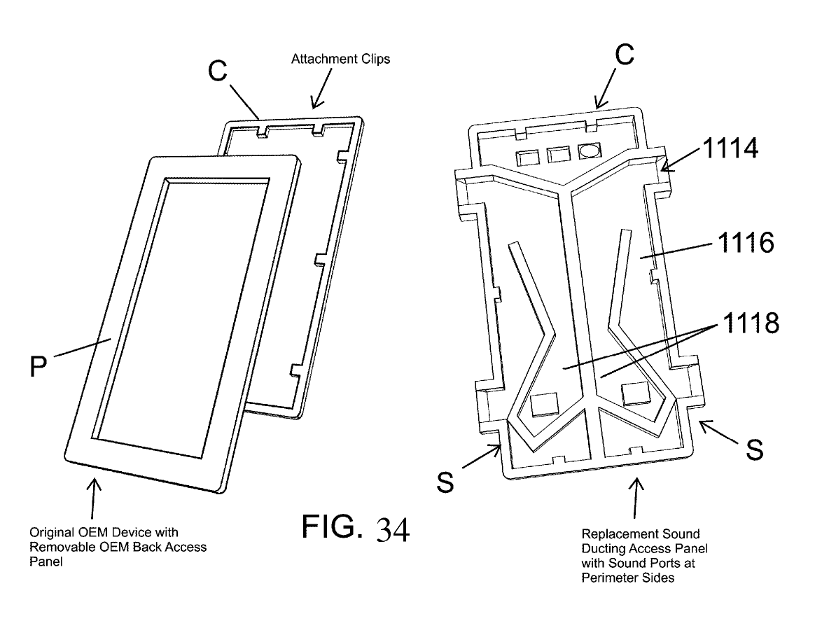

Referring to FIGS. 33 and 34, the numeral 1110 designates a device incorporating the sound wave harness and concentrating technology of the present invention. For example, a standard front panel or bezel (not shown) may be removed and replaced with a modified front panel 1112 that incorporates one or more outlet opening 1113. Similar to the covers described herein, the outlet openings may be located adjacent the corners of the device and along the sides so that the sound is directed the user. To harness the sound waves from a speaker or speakers S supported in the device, for example on a clip C, an insert 1114 may be placed between a standard back panel P (or a modified back panel) and the clip, which includes a plenum space and one or more channels 1118 of the types described above in reference to the covers.

For example, insert 1114 includes a base wall 1116 with a plurality of upwardly extending walls 1122 that form the channels (1118) for harnessing sound from speakers S and directing the harnessed and concentrated sound waves to openings 1113. Similar to cover 1010, some of the outlet openings may share a channel and be located at the end of the shared channel or as may have their own channels so each channel is associated with an outlet opening.

In each of the above covers or inserts or panels, the covers or inserts or panels may be formed from a variety of different materials, including multiple materials. For example, the covers or inserts or panels or parts of the covers or inserts or panels may be molded from a plastic, wood, metal, polymers, rubber, including clear or translucent material, such as clear or translucent plastics. Further, each of the covers or inserts or panels may be formed from injection molding, rotational molding, blow molding, compression molding, thermoforming, multishot molding, stamping, die casting, machining, or forging, including an insert molding process where one or more portions of the cover is preformed from one material, and another portion of the cover is molded over the preformed part(s) from another material.

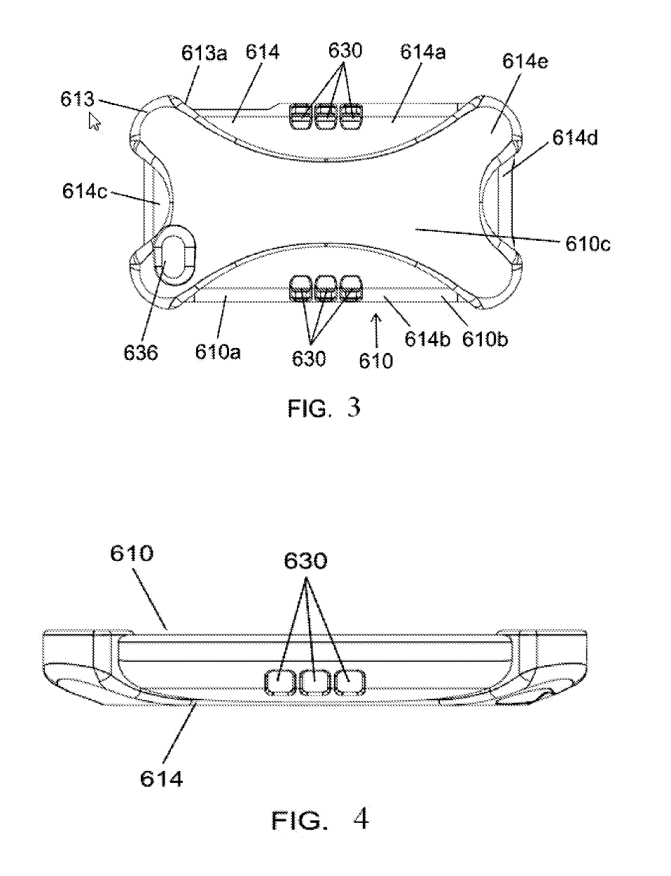

For example, referring FIG. 3, the base wall 614 of cover 610 may be formed from inserts 614a, 614b, 614c and 614d which are preformed from a relatively rigid polymeric material, such as a plastic, which is placed into a mold and then molded with a second material over the inserts forming the balance of the back wall 614e. For example, wall 614e may be formed from a more flexible and energy absorbing material, such as a structural gel, silicone, rubber or other elastomeric materials.

Alternately, the covers, inserts, and panels may be molded using two shot molding with one or more portions of the covers, inserts, and panels being molded with a first material and another or other portions of the covers, inserts, and panels being molded from a second material. In this manner, the covers, inserts, and panels may be formed using materials that can optimize it for the desired function. For example, at least a portion of the covers, inserts, and panels may be formed from a flexible elastic material to provide a more energy absorbing characteristic for the covers, inserts, and panels, while, for example, the base wall or at least the inwardly facing side of the base wall may be formed from a more rigid material to direct the sound waves and limit the absorption of the sound waves into the cover. Additionally, portions of the channels may be selectively formed from materials with more sound absorbing characteristics, such as less dense material or rubber or rubberized material, to absorb selected frequencies (or frequency) of the sound waves to adjust the tone emitted by the covers, inserts, and panels and thereby filter out one or more desired frequencies. For example, the respective base walls or side walls of the channels may be formed from materials that absorb some of the high frequency range sound waves thereby reduce the tininess of the sound waves emitted from the respective chambers or openings of the covers, inserts, and panels. Alternately, the base wall or side walls of the respective channels may be formed from material that absorb some of the low frequency sounds of the sound waves to reduce the base sounds of the sound waves emitted by covers, inserts, and panels. In addition to concentrating the sound waves, the respective covers, inserts, and panels may be configured by way of material selection or geometric selection (e.g. forming the channel from thin, flexible walls) to enhance or suppress certain frequencies of the sound waves emitted by the speaker. Further, a sound absorbing material may be applied thereto, for example, by dipping, spraying, or by way of an adhesive.

While several of the covers are illustrated with a split construction, as described, the covers may be formed from materials that are sufficiently flexible to allow a unitary construction. For example, when made from a flexible material such as gel or silicone, the channels may be formed from inserts that are pre-molded or formed during two shot molding.

Accordingly, when mounted to or in a handheld device with one or more speakers, the plenum space and/or channels of the present invention provide improved sound volume (perceived volume) and/or quality.

While several forms of the invention have been shown and described, other changes and modifications will be appreciated by those skilled in the relevant art. For example, in some devices the speakers may be provided at other locations, therefore, the number, size, shape and locations of the outlet channels and access may vary from device to device. Therefore, it will be understood that the embodiments shown in the drawings and described above are merely for illustrative purposes, and are not intended to limit the scope of the invention which is defined by the claims which follow as interpreted under the principles of patent law including the doctrine of equivalents. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “the,” is not to be construed as limiting the element to the singular.

1. A cover for a handheld device, the handheld device having a device body and a speaker, the speaker having an output, said cover comprising:
a cover body, said cover body configured for covering at a portion of the device body and for covering the speaker, said cover body forming an outlet opening; and
a channel for communication with the speaker and for harnessing and concentrating sound waves from the speaker to said outlet opening, with said channel having a length and a cross section increasing in magnitude along the length of the channel wherein the volume of the sound waves emitted from said outlet opening appear to increase over the sound waves emitted from the speaker without the use of power.

2. The cover according to claim 1, wherein said cover body forms a plenum space, said channel in communication with the plenum space for directing the sound waves to the plenum space, and said plenum space being in communication with said outlet opening.

3. The cover according to claim 1, wherein said cover body includes a base wall and a perimeter wall, said perimeter wall extending around and from said base wall, and said perimeter wall forming said outlet opening.

4. (canceled)

5. (canceled)

6. The cover according to claim 1, wherein said cover body includes a base wall and a perimeter wall, said perimeter wall extending around and from said base wall, said base wall having said opening.

7. The cover according to claim 2, wherein said channel is formed by a pair of side walls, said side walls diverging in the direction of said plenum space.

8. The cover according to claim 7, further comprising a second channel, said second channel in communication with the plenum space and said opening for directing the sound waves from the plenum space to the opening.

9. The cover according to claim 8, wherein said second channel is formed by a pair of side walls, said side walls diverging in the direction of said opening.

10. The cover according to claim 1, wherein said cover body forms a shelf for supporting a card internal to said cover when the cover is mounted to a device.

11. A cover for a handheld device, the handheld device having a device body and a speaker, the speaker having an output, said cover comprising:
a cover body, said cover body configured for covering at a portion of the device body and for covering the speaker, said cover body forming an outlet opening; and
a plenum space formed by said cover body or by an insert in said cover body, said plenum space configured for communicating with the speaker when the cover is mounted to the handheld device and for directing and for concentrating sound waves from the speaker to said outlet opening wherein when the cover is mounted to the handheld device the volume of the sound waves emitted from said outlet opening appear to a user to be increased over the sound waves emitted from the speaker without the use of power.

12. The cover according to claim 11, wherein said cover body or insert is adapted to absorb and thereby filter a selected range of frequencies of the sound wave.

13. The cover according to claim 12, wherein said cover body or insert includes a material or structure that absorbs and thereby filters the selected range of frequencies of the sound wave.

14. The cover according to claim 12, wherein said cover body or insert includes a coating applied thereto that absorbs and thereby filters the selected range of frequencies of the sound wave.

15. The cover according to claim 11, further comprising a channel, said channel in communication with said plenum space and said speaker for harnessing and concentrating sound waves emitted by said speaker.

16. (canceled)

17. An electronic hand-held device comprising:
a housing having an outlet opening;
a speaker spaced from said outlet opening;
a plenum space configured to be in communication with said speaker and said outlet opening to direct and concentrate sound waves emitted from said speaker to said outlet opening wherein the volume of the sound waves emitted from said outlet opening appear to a user to be increased over the volume of the sound waves emitted from the speaker without the use of power.

18. The device according to claim 17, further comprising a channel, said channel being in communication with said speaker and said plenum space and for harnessing and concentrating the sound waves emitted from said speaker.

19. The device according to claim 18, wherein said channel has a closed cross-section, and said closed cross section increases in magnitude in the direction from said speaker to said plenum space.

20. A method of directing sound from a speaker in a hand-held device, said method comprising:
harnessing the sound waves emitted from the speaker;
concentrating the sound waves; and
outputting the harnessed and concentrated sound waves at a location spaced from the speaker wherein the volume of the sound waves output at the location appear to a user to be increased over the sound waves emitted from the speaker without the use of power.

21. (canceled)

22. The method of directing the sound from a speaker in a hand-held device according to claim 20, wherein said outputting includes outputting the harnessed and concentrated sound waves at two or more locations spaced from the speaker.

23. The method of directing the sound from a speaker in a hand-held device according to claim 20, further comprising absorbing a selected frequency of the sound waves to thereby filter the selected frequency from the harnessed and concentrated sound waves output at the location.
